(19) United States
(12) Patent Application Publication
(10) Pub. No.: US 2010/0174813 A1
(43) Pub. Date: Jul. 8, 2010

(54) METHOD AND APPARATUS FOR THE MONITORING OF RELATIONSHIPS BETWEEN TWO PARTIES

(75) Inventors: Adam Hildreth, LEEDS (GB); Peter Maude, LEEDS (GB)

Correspondence Address: INTELLECTUAL PROPERTY / TECHNOLOGY LAW, PO BOX 14329, RESEARCH TRIANGLE PARK, NC, 27709, US

(73) Assignee: CRISP THINKING LTD., Leeds (GB)

(21) Appl. No.: 12/629,756

(22) Filed: Dec. 2, 2009

Related U.S. Application Data
(63) Continuation-in-part of application No. PCT/EP08/56939, filed on Jun. 4, 2008.

(30) Foreign Application Priority Data
Jun. 6, 2007 (GB) 0710845.9
Apr. 18, 2008 (GB) 0807107.8

(51) Int. Cl. G06F 15/173; G06F 15/16

(52) U.S. Cl. 709/224; 709/225

(57) ABSTRACT

A computer implemented method and data processing device for assessing electronically mediated communications is described. A plurality of messages sent by a first party are captured. The content of the messages is processed to determine a quantitative metric reflecting a first property. The behavior over time of the quantitative metric is analyzed to assess the nature of a relationship involving the first party.

### CROSS REFERENCE TO RELATED APPLICATIONS

This is a continuation-in-part under the provisions of 35 USC §120 of International Patent Application No PCT/EP08/056,939 filed Jun. 4, 2008, which in turn claims the priority of Great Britain Patent Application No. 0710845.9 filed Jun. 6, 2007 and the priority of Great Britain Patent Application No. 0807107.8 filed Apr. 18, 2008. The disclosures of all of the foregoing applications are hereby incorporated herein by reference in their respective entireties, for all purposes, and the priority of all such applications is hereby claimed under the applicable provisions of 35 USC §119 and 35 USC §120.

### FIELD OF THE INVENTION

The present invention relates to a communications apparatus, and in particular to methods and apparatus for monitoring of relationships between two parties using said communications.

### BACKGROUND OF THE INVENTION

Electronic communication systems allow people to communicate without being physically present at the same location. A number of electronic communications mechanisms exist, such as telephony, email, text or SMS messaging and instant messaging. Although these electronic communications systems bring advantages in the ease of communication between parties, they can also bring disadvantages. For example, the identity of the parties to the communication can not be reliably confirmed, nor can the honesty of the parties easily be determined.

One particular area where the anonymity of electronic communications is a particular problem is in the grooming of children by pedophiles, in which an adult can, for example, pose as being a child in order to form a relationship with a child to be exploited.

There are many other areas in which the anonymity of electronic communications can also give rise to problems, such as gambling, espionage, industrial espionage, terrorism, security, legal compliance and other activities in which important secret information is transmitted between parties using electronic communications.

Hence, it would be advantageous to be able to identify inappropriate relationships between two parties based on their communications so as to be able to take action to prevent, or otherwise intervene, in their communications.

### PRIOR ART

A number of prior art documents are known which attempt to limit access to various websites based on monitoring a user's behavior. For example, U.S. Pat. No. 5,835,722 (Bradshaw et al) teaches system to control content and prohibit certain interactive attempts by a person using a PC. To achieve this, the software monitors: mouse actions, email traffic, and browsing websites. The system of this patent application keeps its own databases and prevents user action implying unwanted content by blocking the system, unless a supervising adult approves of an action.

US Patent Application Publication No. US 2003/0033405 (Perdon) teaches a system and method to analyze behavior of a plurality of users, defining a likelihood for a next step, monitor a specific user and according to his personal browsing history provide material that might be most interesting to him. The system is geared around the idea of providing targeted content that might be of interest to the individual user.

PCT Patent Application Publication No. WO 2005/038670 A1 teaches a system and a method to limit access to internet content using a device independent from the PC: This device analyzes websites, specifically checking the hyperlinks within these websites and checking them against a database of suspect websites. Access is granted depending on whether a match is found or not.

US Patent Application Publication No. 2002/0013692 A1 teaches an electronic email system that identifies e-mail that conforms to a language type. A scoring engine compares electronic text to a language model. A user interface assigns a language indicator to an e-mail item based upon a score provides by the scoring engine. Basically, emails are flagged graphically, according to their language content.

U.S. Pat. No. 6,438,632 B1 teaches an electronic bulleting board system that identifies inappropriate and unwanted postings by users, using an unwanted words list. If an unwanted posting is identified, it gets withdrawn from the bulletin board, the user gets informed of this fact. Further, a person administrating the bulletin board gets informed about this message, by email.

US Patent Application Publication No. 2007/0214263 A1 teaches an online-content-filtering method and a device. The device receives the content from a network. The method includes a content analysis step, a step consisting of searching an environment of the content via the network, an environment analysis step, a filtering decision step which is performed as a function of a set of decision rules that is dependent on the results of the content and environmental analysis step and a transmission step in which the content may or may not be transmitted to the computer depending on the results of the filtering decision step.

US Patent Application Publication No. 2003/0126267 A1 teaches a method and apparatus for preventing access to inappropriate content over a network based on audio or visual content by restricting access to electronic media objects that have objectionable content. When a user attempts to access an electronic media object at least any one of the audio or visual content of the electronic media object is analyzed to determine of the electronic media object contains any predefined inappropriate content. The predefined inappropriate content may be defined by user-specific access privileges. The user is prevented from accessing the electronic media object if any predefined inappropriate content if found in the electronic media object.

PCT Patent Application Publication No. WO 01/33314 A2 teaches an adaptive behavior modification system providing a personalized behavior modification program and assisting a user in complying with the behavior modification program by continuously learning about the user and providing information, advertisements and products that aid the user in achieving desired goals through behaviors modification.

PCT Patent Application Publication No. WO 02/06997 A2 teaches an electronic mail system. The electronic mail system identifies electronic mail that conforms to a language type. A scoring engine compares electronic text to a language model. A user interface assigns a language indicator to an electronic mail item based upon a score provided by the scoring engine.

PCT Patent Application Publication No. WO 2004/001558 A2 teaches a system and method for online monitoring of and interaction with chat and instant messaging participants. The system and method includes automatically monitoring text-based communications of one or more chat room to determine if a monitoring event has occurred. The communications are monitored and input to a number of pattern recognizing modules. The pattern recognizing modules analyze aspects of the communications by implementing algorithms.

PCT Patent Application Publication No. WO 02/080530 A2 teaches a system for parental control in video programs based on multimedia content information. The system for parental control filters multimedia program content in real time based on a stock and a user specified criteria. The multimedia program is broken down into audio, video and transcript components so that sound effects, visual components, objects and language can be analyzed collectively to make a determination as to whether any offending material is being passed along the multimedia program.

A report by Greenfield et al “Access prevention techniques for internet content filtering” has been published for the National Office for the Information Economy of the Australian Government.

The report provides an overview of the principles behind internet content filtering by blocking ISPs on URL matching.

Finally, an article by L. Penna et al “Challenges of Automating the Detection of Pedophile Activity on the Internet”, Proc 1^{st} International Workshop on Systematic Approaches to Digital Forensic Engineering (SADFE '05) outlines the need for research into the process of automating the detection of pedophile activities on the Internet and identifies the associated challenges of the research area. The paper overviews and analyzes technologies associated with the use of the Internet by pedophiles in terms of event information that each technology potentially provides. It also reviews the anonymity challenges presented by these technologies. The paper presents methods for currently uncharted research that would aid in the process of automating the detection of pedophile activities on the Internet. The paper includes a short discussion of methods involved in automatically detecting pedophile activities

### SUMMARY OF THE INVENTION

A first aspect of the invention provides a method for the monitoring of relationships between two parties which comprises capturing a communication between the two parties, processing the communication to obtain a set of metrics, and then processing the set of metrics with a stored set of values to establish the nature of the relationship.

By carrying out this method inappropriate relationships between two parties can be identified. Such inappropriate relationships include, but are not limited to pedophile grooming relationships, gambling relationships, industrial espionage relationships and financial fraud relationships. If necessary a third party can be notified of the relationship to allow action to be taken.

The invention also provides an apparatus for monitoring the relationship between two parties. The apparatus comprises a buffer memory for storing a plurality of communications between the two parties, a communications processor for processing the plurality of communications in order to establish a set of metrics, a database storing a set of values, and an engine for processing with the set of metrics and the set of values to produce an indicator representative of the relationship between the two parties.

A third aspect of the invention includes an interface to an application program. The interface is adapted to monitor a plurality of communications between the two parties and comprises an identifier routine for passing identifiers representing the two parties from the application program to a monitoring system, a content routine for passing the content of the plurality of communications between the two parties to the monitoring system. The monitoring system processes the plurality of communications with a set of metrics to establish the nature of the plurality of communications between the two parties.

A fourth aspect of the invention includes a listener device for monitoring a plurality of communications between two parties comprising an interceptor for intercepting the plurality of communications between the two parties, a transmitter for passing at least identifiers representing the two parties and the content of the plurality of communications to a monitoring system. The monitoring system processes the plurality of communications with a set of metrics to establish the nature of the plurality of communications between the two parties.

A fifth aspect of the invention includes a method for generating a set of values indicative of a relationship between two parties. The method comprises obtaining at least two training sets with a plurality of documents, each one of the at least two training sets representing an aspect of the relationship between the two parties, identifying a set of domains representing the relationship, processing the plurality of documents from each of the at least two training sets to establish a set of values for each one of the domains for each of the at least two training sets, clustering the set of values for each of the at least two training sets and establishing a boundary between the clustered set of values.

### DESCRIPTION OF THE DRAWINGS

FIG. 1 shows a schematic block diagram of a communications network including a data processing device according to a first aspect of the invention;

FIG. 2 shows a high level process flow chart illustrating a conversation assessment method according to the invention;

FIG. 3 shows a schematic block diagram of illustrating the components of an embodiment of the software architecture of the data processing device;

FIG. 4 shows a schematic process flow chart illustrating operation of the software shown in FIG. 3;

FIG. 5 shows a graphical representation of the relationship between components used in a document indexing process;

FIG. 6 shows a database schema used by a context classification engine;

FIG. 7 shows a process flow chart illustrating operation of the document indexing process;

FIG. 8 shows a process flow chart illustrating the generation of scores by the context classification engine;

FIG. 9 shows a data structure used to represent a plurality of conversation DNA scores for a number of conversation segments between parties A and B; and

FIG. 10 shows a graphical representation of segmentation of DNA dimensions over time as part of a statistical approach to relationship analysis.

Similar items in different Figures share common reference numerals unless indicated otherwise.

### DETAILED DESCRIPTION OF THE INVENTION

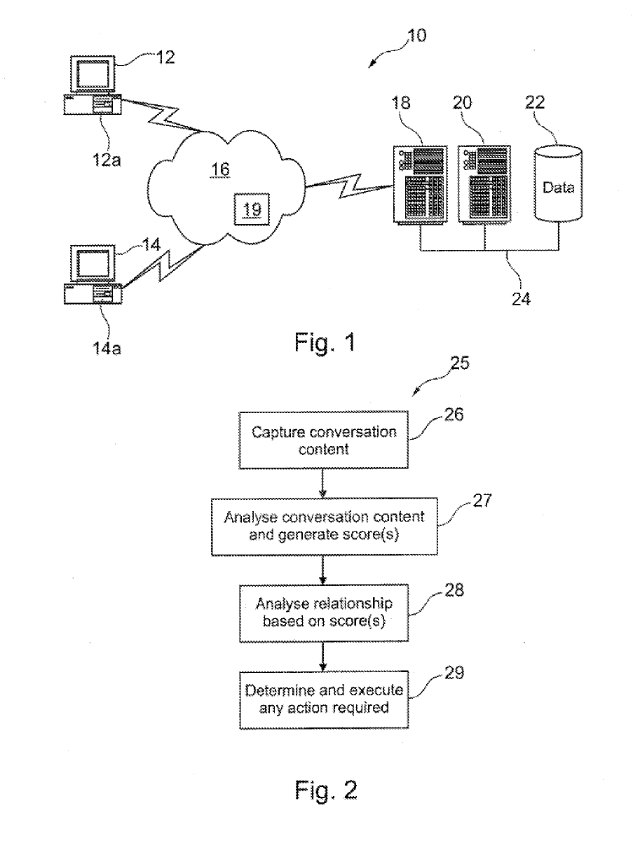

With reference to FIG. 1 there is shown a schematic block diagram of an example communication system 10 in which the present invention can be used. Communication system 10 includes a first personal computer 12 belonging to a first party and a second personal computer 14 belonging to a second party. The first and second personal computers 12 and 14 are each connected via communications links to a wide area network 16, such as the internet. The network 16 and communications links may be wired, wireless or a combination thereof. It will be noted that the first personal computer 12 and the second personal computer 14 could also be other communications devices, such as smartphones, PDAs and the like.

An applications server 18 is also provided in communication with network 16 and hosts conversation assessment and control software 19 according to the invention. A database server 20 can also be provided together with a database 22. The database 22, the database server 20 and the application server 18 can all be connected by a local network 24. In another embodiment, the application server 18 and the database server 20 may be combined in a single computing device or may be provided distributed over multiple computing devices. Further, the application server 18 may communicate with a web server (not shown) which is in communication with the network 16, rather than being directly in communication itself. The web server (not shown) may host, or provide services, to a web site so that the conversation assessment and control software 19 functionality can be provided as part of, or to, the web site.

In the embodiment described below, the conversation assessment and control software 19 operates on the application server 18. In other embodiments, parts of the conversation assessment and control software 19 may be distributed between the application server 18, one of the personal computers 12, 14, and in other embodiments the conversation assessment and control software 19 can be provided entirely locally on the personal computers 12, 14.

The personal computers 12 and 14 each include a messaging application 12a and 14a, such as an email or instant messaging application, using which messages 17 can be sent between the personal computers 12, 14 via the network 16. It will be appreciated that the invention is not limited only to such modes of communication. For example, additionally, or alternatively, a message could be sent via a short message service (SMS, referred to as text messaging or texting) or MMS using the other communications devices. If the text message is being sent to one of the personal computers 12, 14 then at some stage the text message will be routed over the communications network 16 from a telephony network. If the text message is being sent entirely over the telephony network, then the application server 18 is provided with a communication link to a part of that telephony network. One example of the part of the telephone network could be a base station or picocell to which a mobile communications device (not shown) is connected.

Alternatively, or additionally, the invention can also be used for standard telephony in which a speech-to-text converter is used to convert the spoken words into text in the telephony network 24 and then the text is passed to the application server 18.

The invention will be described below in the context of helping to prevent grooming of children by pedophiles over the internet. However, it will be appreciated that the invention is not limited to that specific application and has a wide number of applications. For example, the invention can be used in security applications, e.g. to help identify potential terrorists, owing to the characteristics of the conversation between the computer users via the communications network 16. The invention can also be used to help identify other inappropriate communications, such as industrial espionage, insider dealing, gambling fraud, business ethics compliance and the like.

FIG. 2 shows a flow chart illustrating a method 25 of the invention at a high level. The method includes capturing 26 at least some of the content of a communication such as a conversation, between at least two parties communicating in an electronically mediated manner, for example, by email, instant messaging, text messaging in an internet chat room, SMS, MMS etc. Then at 27, the content of the communication is subject to various types of analysis to generate at least one, but typically a set of scores or metrics which can be considered to characterise a property of the communication. The score or scores generated at 27 are sometimes referred to herein as the “DNA” of the communication. That is, by analogy with DNA sequences, by analysing the patterns in the scores, a higher level property of the communication can be identified, such as whether one of the parties is likely to be a pedophile. At 28, the score or scores are subject to at least one, or possibly several, analytical techniques in order to arrive at an assessment of the relationship between the at least two parties to the communication. That analysis can be carried out on only one side of the communication, both sides of the communication, or one or both sides of multiple different communication, all including at least one common party. The assessment may, for example, be a likelihood or probability that the communication has a particular property, e.g. is a grooming conversation. Based on the assessment of the communication, at 29 it can be determined whether any particular action or actions are required and if so then the required actions can be carried out. For example, it may be determined that a message to a trusted party should be generated and sent, or further communication between the parties should be blocked. The method assesses the communications as they evolve over time in order to be able to more accurately identify acceptable and non-acceptable conversations. Examples of trusted parties include parents or guardians of children having the conversations, compliance officers monitoring business ethics, or fraud investigators.

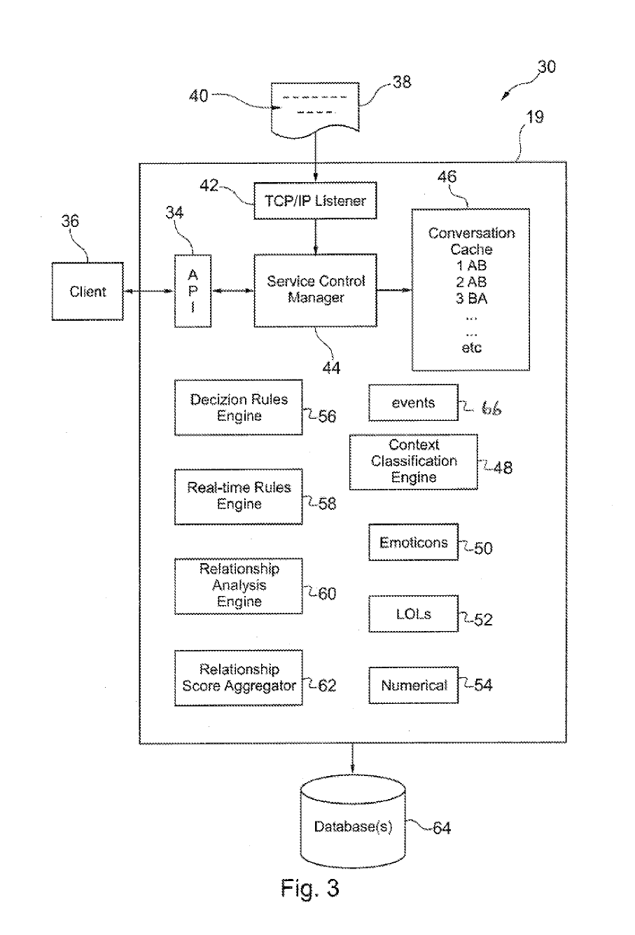

With reference to FIG. 3 there is shown a schematic block diagram illustrating one embodiment of a software architecture 30 for the conversation assessment and control software 19. Other embodiments also according to the invention are described later on.

In the following, a “conversation” will be used to refer to a sequence of messages sent by at least a first party to a second party. As discussed above, those sequences of messages may be simply posted to a bulletin board or similar or may be sent to at least one specific second party. The conversation can include reply messages sent by the second party. That conversation can be made up of any number and sequence of individual messages sent by or passed between the parties and is not limited to multiple a strict sequence of replies and responses. For example one of the parties may send multiple messages not all or any of which will generate a response or responses. Further, a “conversation” can also be considered to include a message sent by one party and intended for multiple parties, such as by a bulletin board, and which may result in numerous reply messages from multiple different parties, wherein each unique combination of parties can be considered to give rise to distinct conversations.

The invention analyzes conversation in terms of segments of a conversation. A segment, as used herein, refers to a number of contiguous elements of the messages of a one of the parties in a conversation, for example a fixed number of words, e.g. 100 words, or a fixed number of lines of messages, e.g. 50 lines, sent by one of the parties. The number of words or lines in a segment can vary depending on the application of the invention and the difficulty in assessing the nature of the conversation. Preferably at least a few tens of words or lines are present in a segment. The use of segments helps to prevent the skewing of the analysis and assessment of conversations which can otherwise occur owing to conversation elements with a high frequency of occurrence and which can be of little help in assessing the conversation, such as “Hi”. It will be appreciated that “words” herein can include abbreviations and symbols as used in emails and text message and is not limited to grammatically correct words.

As illustrated in FIG. 3, the software architecture 30 includes an API 34 via which the conversation assessment and control software 19 can interact with a client application 36 to which the software is providing conversation assessment and control services. Depending on the environment in which the invention is being used, the client application 36 can be a number of different applications. For example, the client application 36 can be a part of a web site, a part of an instant messaging service, a part of an email service or similar. In the example embodiment being described, the client application 36 is an email service and 38 represents a message being handled by the email service as part of a conversation between the first party and the second party.

The message 38 from the first party is being transmitted over the communications network 16 and includes text content 40 which is intercepted by the software architecture 30. For example, the text content 40 of the first message may be “How RU”. The software architecture 30 includes code implementing a listener module 42 which provides a service listening on a TCP/IP port for incoming connections from the communications network 16, or a web server, and translates the incoming message 38 into a message object for further processing by the software architecture 30.

A service control manager 44 is also provided and is implemented by code. The service control manager 44 provides a service which enables the entry point for processing of the messages 38, and which interacts with the client application 36 via the API 34. The service control manager 44 passes message objects 33 to a conversation cache 46 for assembling the messages 38 into conversation segments and which calls a number of other modules at different stages of processing of the message objects 33. The service control manager 44 controls the overall workflow of the software. The service control manager 44 is a system which defines a chain of command for the different modules or components and which can define synchronous and asynchronous call graphs thereby defining the workflow processing carried out on the message objects 33.

This software architecture 30 includes a number of pluggable components examples of a number of which are shown in FIG. 3. Depending on the workflow required for a particular application of the invention different numbers and combinations of these components can be used. For example, a message object 33 can be processed by a context classification engine 48 and then a real time rules engine 58. After processing by the real time rules engine 58, the service control manager 44 can pass the result to a decision rules engine 56. Depending on the decision reached, control can be returned to the service control manager 44 which can then notify the client application 36 to allow the conversation to continue, or an events component 66 may be called in order to instigate an event, such as sending an email message to the trusted party indicating that a certain type of conversation has been identified.

The software architecture 30 can be configured to operate synchronously or asynchronously with the messaging system. For example, in an asynchronous embodiment, the invention may just receive copies of the messages 38 from an Internet Service Provider (ISP), which continues passing the messages 38 in real time to the second party. The invention can then assess the messages 38 in the background so as not to interrupt the network traffic of the Internet Service Provider. The software 30 can then notify the ISP later on if a certain type of conversation is identified so that the ISP can determine whether to start blocking communications from one of the first party or the second party. This notification is performed, for example, through the events controller 66.

In a synchronous embodiment, such as an instant messaging application, the software architecture 30 can hold the messages 38 being received, analyze the messages 38 and then determine whether to allow individual ones of the messages 38 to be passed on to the other party or not. Hence, the assessment is synchronous with the actual passing of messages 38.

The decision rules engine 56 can be used to determine what action or actions are to be carried out. The decision rules engine 56 can maintain two work flows. A first work flow can be executed before a real time rules engine 58 is called and can prevent the real time rules engine 58 executing. For example, it may have been determined that an incoming message 38 has been sent by a party previously determined to be a pedophile and so the incoming message 38 should be blocked. Therefore, there is no need to process the incoming message 38 further.

A second work flow of the decision rules engine 56 can be executed after the real time rules engine 58 and can use the output of the real time rules engine 58 as part of its decision processes. The decision rules engine 56 uses a logical work flow to determine what action to take in relation to the incoming message 38. A logical work flow is constructed declaratively during system configuration. The decision rules engine 56 can access a number of data sources to provide input to its rules, including user configuration data, the output from the real time rules engine 58, the output from the context classification engine 48 and other classification modules 50, 52, 54, relationship analysis data obtained from a relationship analysis engine 60 and relationship score data from a relationship score aggregator 62. Depending on the embodiment, the data can be obtained from the modules, from a database 64 or a combination thereof, and either synchronously or asynchronously.

The specific logic used by the decision rules engine 56 will vary depending upon the particular application. An example implementation of the logic implementing a rule is:

```
<if preference = “GroomingThreshold” operator = “LessThan”
relationship = “GroomingScore”>
      a.  <return response = “Block”/> 20 <else>
      b.  <return response = “Allow”/> </else> </if>
```

Hence, if a grooming score generated by the relationship score aggregator 62 is greater than a grooming threshold set by the user configuration data, then the decision rules engine 56 returns the response “Block” to the service control manager 44 which communicates with the client application 36 via the API 34 to block further communications. Otherwise, the message 38 is allowed to pass through by the conversation assessment and control software 19. The message 38 can be passed as received or as amended by the conversation assessment and control software 19. For example a further rule implemented by logic may be that if swear words are present in the incoming message having a score greater than a threshold value then the swear words are removed from the text of message 38 and replaced by asterisks in the outgoing message 38. Similarly, logic can be included to cause any telephone number identified in the incoming message 38 to be removed before the incoming message 38 is allowed to pass. Hence, an amended message 38 can be allowed to be passed by the conversation assessment and control software 19 rather than the text of the incoming message 38 as originally transmitted.

As mentioned above, the service control manager 44 can cause a conversation segment to be analyzed by a context classification engine 48. The context classification engine 48 analyzes the textual content of the conversation segment in order to classify and score the conversation in a number of domains. The context classification engine 48 can also generate metadata about the message 38. Operation of the context classification engine 48 will be described in greater detail below.

The real time rules engine 44 component can be used to allow a customized set of rules to be applied to conversation segments 17a in real time, if required. The real time rules engine 58 has access to the output of the classification modules 48, 50, 52, 54, each of which can be used to assess the presence of certain characteristics of the message 38. For example, a numerical module 54 can be used to identify any telephone numbers. Another classification module (not shown) can be used to identify other contact details in the message, such as email addresses. Another classification module (not shown) can be used to identify any banned phrases. Another module (not shown) can be used to identify any swear words in the message 38. Other modules can look for specific characteristics of the conversation segment. For example, an emoticons module 50 can identify the number and type of emoticons present in the conversation segment, and a laugh out loud (LOLs) module 52 can identify the number of instances of LOL appearing in the conversation segment. Other types of classification modules can also be provided, such as a classification module which counts the types and frequencies of punctuation in a conversation segment.

For a particular application of the invention, a customized set of rules can be applied to the conversation segment 17a in real time. The real time rules engine 58 can operate for the conversation segment currently held in the conversation cache 46 and the classification modules can access the text of the conversation segment 17, 38, and the metadata for the message segment and the score data output by the context classification engine 48 can be made available to the real time rules engine 58. The output from the real-time rules engine 58 can be passed to the decision rules engine 56 so that the decision rules engine 56 can use that output as part of the determination of what action to take.

The classification modules to be used by the real time rules engine 58 and the order of execution is determined via system configuration. Some of the classification modules can be optional and will only execute dependent on user configuration data. In other embodiments, some or all of the classification modules can analyze a conversation on a message by message basis rather than using conversation segments.

The conversation cache 46 receives the message objects for any messages passed between a pair of parties, A and B, by the main service control manager 44. For example as illustrated in FIG. 3, the conversation cache 46 currently holds a first message which was sent from A to B, a second message which was sent from A to B and a third message which was sent from B to A. The conversation segment 17a to which to add any newly received incoming message 38 can be determined using identity data of the sender and receiver of the current message, for example using the “to” and “from” addresses of an email message. Each message 38 between A and B is added to the preceding messages 38 sent between A and B until the segment length is reached, e.g. 100 words. The conversation segment object is then passed to the context classification engine 48 for analysis and is also stored in the database 64. The conversation cache 46 maintains a cache of the conversation segments 17a for all of the conversations that are currently ongoing and being handled by the software architecture 30. The other modules of the software architecture 30 can query the conversation cache 46 for information on a current conversation. This can be useful for the real time rules engine 44 which may need to analyze previous ones of the messages in the conversation or decisions made on the basis of previous messages in the conversation.

The conversation cache module 46 is also responsible for maintaining the lifetime of the conversation segment 17a. The conversation segment 17a can be ended when the word length limit has been reached and then a new conversation segment 17a is begun. However, if a time out limit is reached during which no new message 38 between the parties A and B is received, then the conversation segment 17a can be considered completed before the usual word length (e.g. 100) has been reached and passed to the context classification engine 48 for processing.

Messages 17, 38 received by the software 30 for the conversation segment 17a that has already timed out are assigned to a new conversation segment 17a for the pair of users (A, B). Once the conversation segment 17a has ended, the conversation cache 46 ensures that the conversation segment 17a is persisted as a new completed conversation segment 17a between the parties (A, B) in database 64 before removing the conversation segment from the conversation cache 46.

A relationship analysis engine 60 is also provided which analyzes the score data generated by the classification modules and stored in a database 64. As indicated above, the scores can be simple statistics, such as average conversation length, frequency of swear words, average number of punctuation marks, etc, and are the quantitative metrics or scores which constitute the conversation DNA analyzed by the relationship analysis engine 60. The result data from the relationship analysis engine 60 can then be used by a relationship score aggregator 62 to try and identify potentially inappropriate relationships between the parties (A, B) to the conversation. The output of the relationship analysis engine 60 and/or of the relationship score aggregator 62 can be used by either work flow of the decision rules engine 56 in order to determine what action the communication assessment and control software 19 should take.

The relationship analysis engine 56 provides one or more analysis modules which operate on the scores generated by the classification modules 48 to 54 and which can be executed in a manner determined by the system configuration. Each analysis module generates one or more relationship scores, being a quantitative metric indicative of the nature of the relationship based on the conversation segment 17. The or each output of the relationship analysis engine 60 can then be passed to a relationship score aggregator 62 which can combine the relationship scores to come up with an overall metric for the nature of the relationship, such as a representation of the likelihood or probability that the relationship is a grooming relationship or a simple classification. In one embodiment, that likelihood can be used as input by the decision rules engine 56 as one factor in determining what action to take. In another embodiment, the relationship score aggregator 62 may simply classify the relationship as being safe or not and pass a result to the events module 66 which takes a predetermined action based on that passed result.

The events module 66 can take input from a variety of the other modules and the service control manager 44 to initiate certain events. For example, the events module 66 can include logic to determine what event or events to initiate based on its different inputs, or more simply to carry out a specific event based on a single input. For example, the event module 66 can be configured to send a warning email to an email account of a parent (or other trusted party) if the relationships score aggregator determines that the relationship is likely to be a grooming relationship.

All the data stored by the conversation cache 46 in database 64 is available to the conversation analysis modules. The database 64 also stores the scores output by the classification engines 48 to 54, the output of the real time rules engine 58 and the output of the decision rules engine 56. The output of any or all of these components can be used by the relationship analysis engine 60 to generate output conversation metrics. The conversation metrics are used by the relationship score aggregator 62 in order to try and identify potentially inappropriate relationships or behavior, based on the behavior with time of a conversation between the two parties 12, 14 (A, B). The relationship analysis engine 60 and the relationship score aggregator 62 will be described in greater detail below.

The software architecture 30 can include a number of administrative applications providing an administrator with the ability to alter system configuration, such as setting user properties, configuring the classification modules, the real time rules engine 58 or the relationship analysis engine 60, altering work flow decision rules for the decision rules engine 56 and similar. An administration module can also be provided for the context classification engine 48 to update dictionaries and other resources used by the context classification engine 48 as described in greater detail below.

Having described the overall software architecture 30 of the communication control software 30, an example of its operation will be described in greater detail with reference to

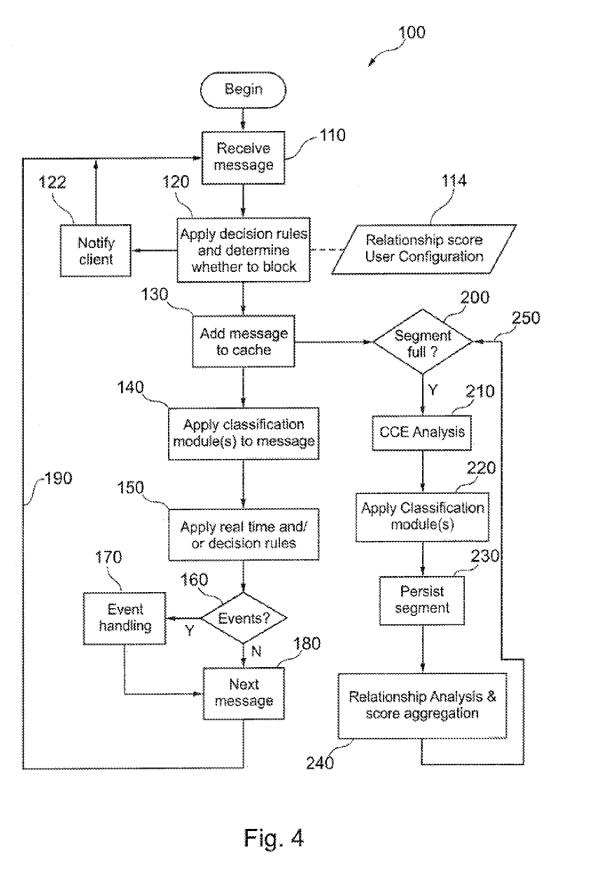

FIG. 4. FIG. 4 shows a process flow chart illustrating a data processing method 100 which can be carried out by the communication assessment and control software 19.

At step 110 a newly received incoming message 38 is captured by listener 42 which generates a message object including the text of the incoming message 38 which is passed to the service control manager 44. The service control manager 44 can call the decision rules engine 56 and an initial decision can be 120 whether the client application 36 needs to take action, such as blocking the message 38, or otherwise needs feedback from the software architecture 30, for example, to block the current message 38 to prevent it being sent to the intended recipient. The decision rules engine 56 applies certain rules using declaratory logic and accesses any relationship data 114 for this conversation, or previous conversations, between the sender and recipient of the message 38.

The decision rules engine 56 can access user configuration data which can be used in the decision rules. For example, the decision rules engine 56 may previously have been determined that the sender or receiver of the message 38 is likely grooming the other party to the conversation. The decision rules engine 56 can include a rule to check whether the messages 38 between the parties 12, 14 should be blocked and if that data value is set true then at step 120 it is determined that the message 38 should be blocked and at step 122, the client application 36 is notified by the service control manager 44 so that the current message 38 is blocked. Further the message object need not be passed for further processing, but can be added to the conversation cache 46 at step 130. Process flow then returns to step 110 at which a next one of the messages 38 is received for processing.

Alternatively, or additionally, the decision rules engine 56 may determine from user configuration data 114 that the message 38 should be blocked. Alternatively, or additionally, if relationship score data 114 is available, having already been generated by the relationship score aggregator 62, then the decision rules engine 58 can apply rules using the relationship score data to determine what action to take. If the message 38 is a first message between the parties 12, 14 then no relationship score data will be available. The relationship score data may only available after at least one conversation segment 17a has been completed between the two parties 12, 14. If the relationship score data is available then the decision whether to block the current message 38 can be made at step 120 using the specified rules and relationship scores. The decision whether to block the message 38 can also be made based on the results of rules applied using relationship scores and rules applied using the user configuration data, and all other combinations of data available to the decisions rules engine 56.

If it is determined at step 120 that further processing of the message 38 is required, then processing proceeds to step 130 at which the message object is added to the conversation cache 46. In this example, the original text of the message 38 is “How R U”. The software 30 may have been configured to carry out some classification on a message by message basis, in which case at step 140 various ones of the classification modules can be applied to the message 38. For example a numerical classification module 54 might be applied to see if there are any telephone numbers in the message 38.

At step 150 the service control manager 44 may determine that the real time rules and or decision rules need to be applied. As explained above, the real time rules can be a customised set of rules to be applied to the message 38 in real time. For example, a swearing classification module applied at step 140 may have identified swear words and a decision to remove some or all swear words from the message 38 can be made at step 150. An item of personal information may have been identified in the message 38 and a decision can be made to remove personal information from the message 38 at step 150.

Alternatively, or additionally, the real time rules engine 58 may generate an output which is used by the decision rules engine 58 to decide what action to take in relation to the message 38. For example a personal information module may simply determine that personal information is present in the message 38, in the form of a telephone number, and assign a risk score or value to the message 38, which risk score or value is then passed to the decision rules engine and used by the decision rules engine 58 in determining what action to take in relation to the message 38.

Applying the real time rules and decision rules at 150 determines what action, if any, to take. As explained previously, the decision rules engine 56 can access all of the data currently associated with the message object, and all previously generated data in order to decide what action to take based on rules implemented in logic. For example a rule may be if a grooming relationship score exceeds a threshold value and the message 38 includes a telephone number then the telephone number should be deleted from the message 38 and a warning email sent to a parent. This logic should prevent the messages 38 including telephone numbers that have been identified as potentially part of a grooming conversation being passed from a child being groomed but should allow messages from friends including telephone numbers to be passed, as those conversations have a low grooming relationship score.

Another example would be to decide to amend the message 38 by removing all swear words having a score higher than a threshold value. This would allow children, or others, to still communicate but would prevent offensive materials from being transmitted. The logic may also look up user preference data to determine the age of the recipient and determine that if the age of the recipient exceeds a threshold then even if the swearing score exceeds the threshold to allow the message 38 to pass unamended as the recipient is an adult.

After the real time rules engine 58 and the decision rules engine 56 have determined what action to take in connection with the current message at step 150, then at step 160 it is determined if events are required and if so then the events module 64 is called which carries out the necessary actions. For example, the necessary actions include removing telephone numbers or swearing in the above example. After event handling has been initiated at 170, or if no events are required, then at step 180, a next message 38 received by the service control manager 44 from the listener 42 is identified and processing returns to step 110 as illustrated by process flow line 190.

It will be appreciated that the next message 38 may not be from the same party or a part of the same conversation as the message 38 previously analyzed, but may be a message 38 from an entirely different party or conversation. Hence the service control manager 44 simply handles the real time processing of messages 38 as they are received and the conversation cache module 46 handles the consolidation of the individual messages 38 into segments of specific conversations as described above.

In embodiments using the context classification engine 48, then the conversations are also analyzed based on the conversation segments. At step 130 a newly received message 38 is passed to the conversation cache 46 and associated with a current conversation segment for the party that sent the message 38. When the conversation segment is determined 200 to be completed, for example by reaching a word limit of 100 words, then the conversation segment for that party is passed to the context classification engine 48 for processing and scoring at step 210. The service control manager 44 passes the conversation segment object including the conversation segment text to the context classification engine 48 which generates various data items and scores which are added to the conversation segment object. Operation of the context classification engine 48 will be described in greater detail below.

The conversation segment object can also be passed to a number of the other classification modules 48 to 54 for analysis at step 220 to generate more scores or metrics for the conversation DNA. After the conversation segment object has been processed, it is persisted to database 64 by the service control manager 44 at step 230. Then at step 240, the service control manager 44 calls the relationship analysis engine 60 to process the scores generated by the context classification engine 48 and the other classification modules at steps 210 and 220 and also the relationship score aggregator 62 to handle the relationship score data generated by the relationship analysis engine 60. Processing then returns to 200 at which it is determined whether another conversation segment is full and ready for processing.

Once the relationship analysis engine 60 and the relationship score aggregator 62 have completed their processing, the results are available to the decision rules engine 56 and/or real-time rules engine 58 so that they can determine what action to take during the main loop of processing illustrated in FIG. 4. Operation of the relationship analysis engine 60 and the relationship score aggregator 62 will be described in greater detail below.

The context classification engine (CCE) 48 determines which of a number of domains the text of the conversation segment falls in and then assigns scores to the conversation segment based on the scores associated with the domains. The domains are predefined by the software 30 and examples of documents (a training set) falling in the domains are processed in order to identify phrases or expressions falling within the different domains.

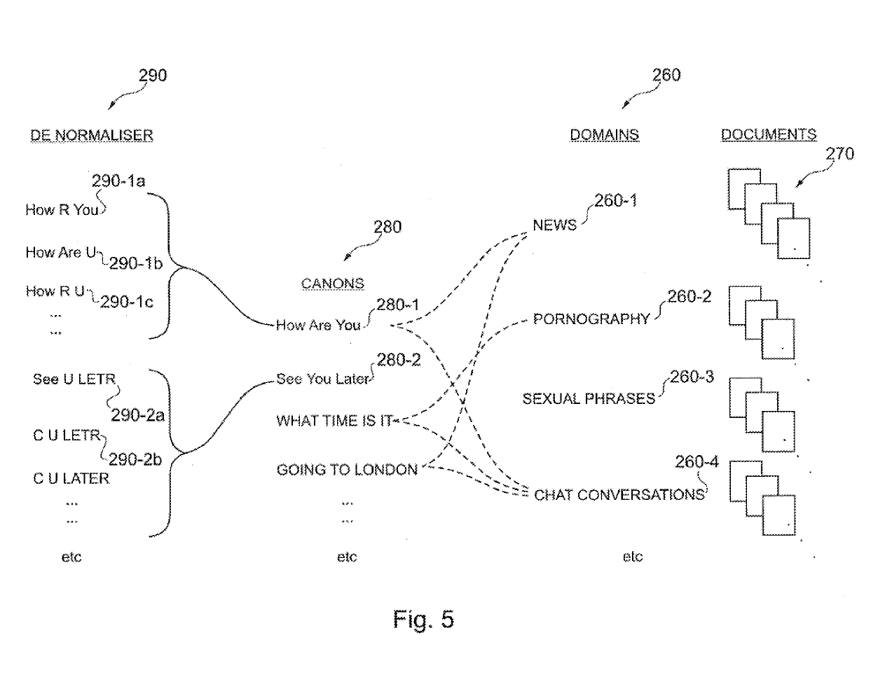

FIG. 5 schematically illustrates the relationship between the canonical phrases, de-normalized phrases, domains and documents which will be referred to further below. A plurality of different domains 260 are selected so as to try and cover many or all types of content that might be present in any conversation. For example, FIG. 5 shows the example domains 260 of news 260-1, pornography 260-2, known sexual phrases 260-3, known chat conversations 260-4, etc. The invention is not limited to these domains 260 and in practice a large number of domains 260 are used. For each one of the domains 260, a number of documents 270 are identified which fall within that domain 260. One document 270 can fall in more than one domain 260, depending on its content. The documents 270 are generally in an electronic format, or can be converted into an electronic format, and can come from various sources, such as publications (magazines, books, etc), websites, electronic documents, copies of emails, text messages, etc. For example documents 270 in the news domain 260-1 might include, news web sites and electronically and traditionally published newspapers. Also, the domain 260 does not need to be wholly or at all generated from the documents 270. Rather, the domain 260 can be associated simply with a group of phrases identified from other sources.

A number of canonical phrases or expressions 280 are defined and form the fundamental distinct building blocks of any of the documents 270 that has been processed. A number of de-normalized phrases 290 are also identified and can be considered equivalent to the canonical phrases 280. For example, the normal canonical phrase 280-1 “how are you” may have the equivalent de-normalized versions “how R you” 290-1a, “how are U” 290-1b, “how R U” 290-1c, etc. As can be seen there is a ‘many to one’ relationship between the de-normalized phrases 290 and each one of the canonical phrases 280. Also, there is a ‘one to many’ relationship between the canonical phrases 280 and the domains 260, so that one of the canonical phrases 280 can be associated with multiple ones of the domains 260. For example, the canonical phrase “how are you” 280-1 may be associated with the domains news 260-1 and chat conversations 260-4, because “how are you” was present in a news document and “how R U” was present in a chat conversation document.

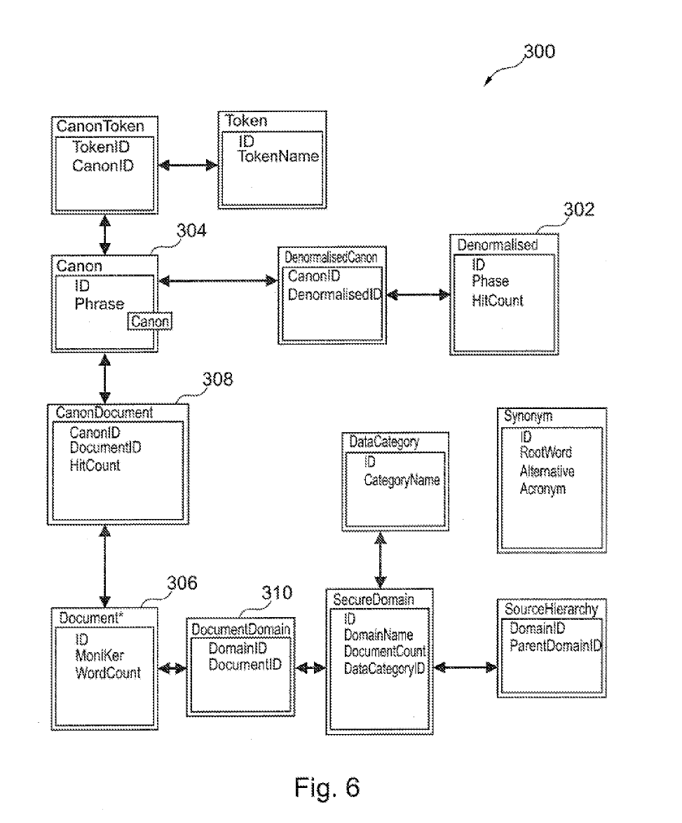

FIG. 6 shows a database schema 300 showing a number of tables by which the denormalized phrase data (Denormalized table 302), canon data (Canon table 304), document data (Document table 306) and domain data (various tables) are organized and related. For example, the Canon Document table 308 represents which documents 270 each of the canonical phrases or expressions 280 is associated with and the Document Domain table 310 represents which domains 260 each document 270 is associated with.

Hence, before the CCE 48 can be used, the documents 270 are analyzed in a training set and indexed according to the method described below. Once the documents 270 have been indexed, the CCE 48 can score phrases present in the conversation segment in real time. Both the document indexing and phrase scoring using a similar phrase based approach. For any segment of text, phrases are extracted over each two, three, four and five word phrase in the segment of text being analyzed, from longest to shortest. For example the segment “The quick brown fox jumps over the lazy dogs” is broken down into the following possible five word phrases:

The quick brown fox jumps
quick brown fox jumps over
brown fox jumps over the
fox jumps over the lazy
jumps over the lazy dogs
each of which is indexed or scored. Then all possible four word phrases are processed:
The quick brown fox
quick brown fox jumps
brown fox jumps over
etc
each of which is indexed or scored and then the three and two word phrases until all possible combinations have been exhaustively processed. This process of phrase extraction is used during document indexing to build up the source data and also during real-time scoring to match against all possible phrases in the incoming conversation segment.

Document indexing is carried out in order to build up statistics and is carried out using a document indexing service running on a separate server (not shown). The text from known sources is assigned to known domains 260 and each combination of phrases from two to five words is stored in the database 300 with a hit count associated with each phrase and the number of words in the document 270. The phrases in many of the domains 260 adhere strongly to the correct English spelling and grammar and are referred to herein as canonical phrases 280. For some domains 260, e.g. Movie Scripts, Chat, etc, the phrases do not adhere as strongly to correct English spelling and grammar but are also considered canonical phrases 280. Also, the English phrases extracted from the documents 270 are denormalized using a set of synonyms to expand to every possible variation of the canonical phrase 280 which is likely to be present in the conversation segments. This includes common spelling mistakes, text and 133t speak, and genuine English synonyms.

As the source of the documents 270 is known and selected, it is possible to build up a profile of what types of canonical phrases 280 occur in which types of the documents 270. Once phrase frequencies for a variety of documents 270 are established, phrase differences between the documents 270 in different domains 260 can be identified. For example, the canonical phrases 280 that appear frequently in the documents 270 in the sexual domain 260-3, and that do not often appear in other domains 260, can then be assigned a high weighting, as being highly characterizing of the content of the conversation in the sexual domain 260-3. Weightings can therefore be assigned on a more objective statistical basis rather than subjectively.

The document indexing service is provided as an always available, always running Windows service. Document text data can be imported and statistically analyzed through the use of a simple XML schema. A “drop folder” is used where XML files can be copied to and a file watch on the folder automatically imports when new files are present. Any API that has access to the drop folder can process documents with human users being able to import without any custom tools. A record of the documents 270 that have been indexed is maintained in a “processed” folder for future reference.

The document text data is imported in XML format that can be serialized into a specific format. An example of the XML format is:

```
<Document>
      a.  <Url>http://www.literotica.com/...</Url>
          <Domain>Sexual: Man/Woman</Domain>
          <Data>
              i. <![CDATA{..Data..
              II. }]>
      b.  </Data>
</Document>
```

where the Url tag identifies the source of the document 270, the Domain tag identifies the particular domain that the document 270 falls in and the Data tag identifies the actual text data.

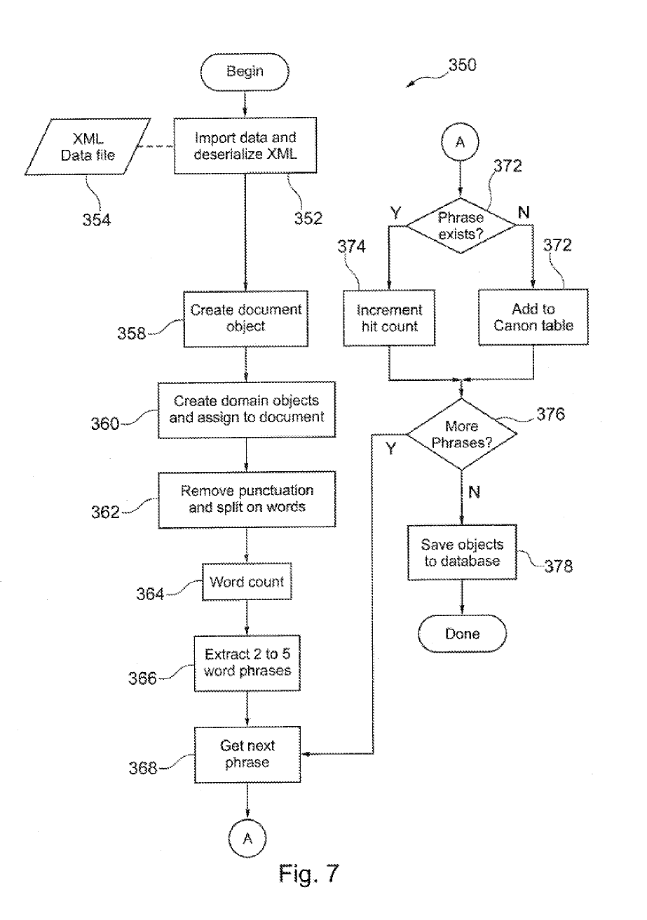

FIG. 7 shows a process flow chart illustrating the document indexing method 350 in greater detail. At step 352 the XML data file 354 is imported by the indexing program and the XML data is deserialized. At step 358 a document object is created for the document 270 being indexed and then at step 360 a domain object is created for each domain 260 in which the document 270 falls and the domain objects are assigned to the document 270. At step 362 all punctuation is removed from the document text data and the text data is split at each word before the number of words in the document 270 is determined at step 364.

Then at step 366 all of the 2 to 5 canonical phrases present in the text data are determined as described above. A first one of the canonical phrases is selected 368 and for the current phrase it is determined 370 whether the canonical phrase already exists. If not then the canonical phrase is added 372 to the Canon table 304 in the database 300 and the hit count for that canonical phrase set to 1. Then it is determined 376 whether there are any canonical phrases remaining which have not yet been processed and if so then processing returns to step 368 and a next one of the remaining canonical phrases is selected. Processing proceeds as described above, and at step 370 processing proceeds either to step 374 if the canonical phrase already exists in which case a counter is updated or to step 372 if the canonical phrase is a new canonical phrase.

When it is determined at step 376 that no further canonical phrases remain to be processed, then processing proceeds to step 378 and the document object and domain objects are stored in the relevant tables of the database 300 as illustrated in FIG. 6. Hence, the indexing method identifies each unique 2 to 5 word canonical phrase present in the document 270, each of which is now an individual canonical phrase. The indexing method allows the frequency of appearance of each canonical phrase in the document 270 to be determined. The number of times each unique canonical phrase appears in the document 270 (the number of hits) can be divided by the total number of words in the document 270 to provide this frequency measure. For example, if the canonical phrase “how are you” appeared seven times in the document 270 which is 1000 words long in total, then the phrase frequency metric would be 0.007. Hence any canonical phrase will have a frequency metric falling in the range of 0 to 1. This phrase frequency metric can be calculated from the data stored in the database 300 as and when needed. Hence, in the above example, the canonical phrase “how are you” would have a phrase frequency metric of 0.007 associated with the domain 260-3 ‘Sexual: man/woman’.

If the same canonical phrase is identified in the document 270 in a different one of the domains 260, e.g. the ‘News’ domain 260-1, then the number of hits is similarly recorded so that a frequency metric for that different domain 260 can also be calculated based on the number of hits for the same phrase in that domain. If the same phrase is identified in a different one of the documents 270 for the same domain 260, e.g. another different document 270 having the canonical phrase in the ‘Sexual: man/woman’ domain 260-3, then the number of hits for that different document 270 is also stored. The number of hits in each different domain 260 is recorded for each different document 270. Acquisition of that data for a reasonable number of the documents 270 eventually allows a reasonably reliable indicator to be calculated of how often a particular phrase tends to occur for any document 270 falling within a particular domain 260.

The exact matching of the canonical phrases 280 with conversation segment text is limited owing to the variety of ways people use to say the same thing depending on the communication medium they are using, spelling, their age, habits, etc. Shortening of words through the dropping of vowels or trailing letters is common in chat data which would otherwise result in a reduction in the frequency of matches between conversation segment text and the canonical phrases 280 being identified. To retain maintainability and also to increase accuracy, the invention uses a phrase expansion method to de-normalize the canonical phrases 280 into many possible variations. A system of synonyms is used to perform the expansion in an offline, scheduled basis.

The synonym logic uses a root word to alternative approach. Root words are words that are found within the canonical phrases 280 but which may have one or more alternatives. For example, the canonical phrase “where do you live” may be one of the canonical phrases 280 in the index. Various synonyms exist for the words in this canonical phrase, such as:

| | |
|---|---|
| where | whr |
| you | U |

and these synonyms result in the following possible expansions that are stored in the de-normalised database 290:
Where do you live
Whr do you live
Whr do U live
Where do U live

Hence the expansion process is used off line to generate the de-normalized equivalents to each canonical phrase 280 and which are stored in the Denormalized table 302 as illustrated in the database schema 300.

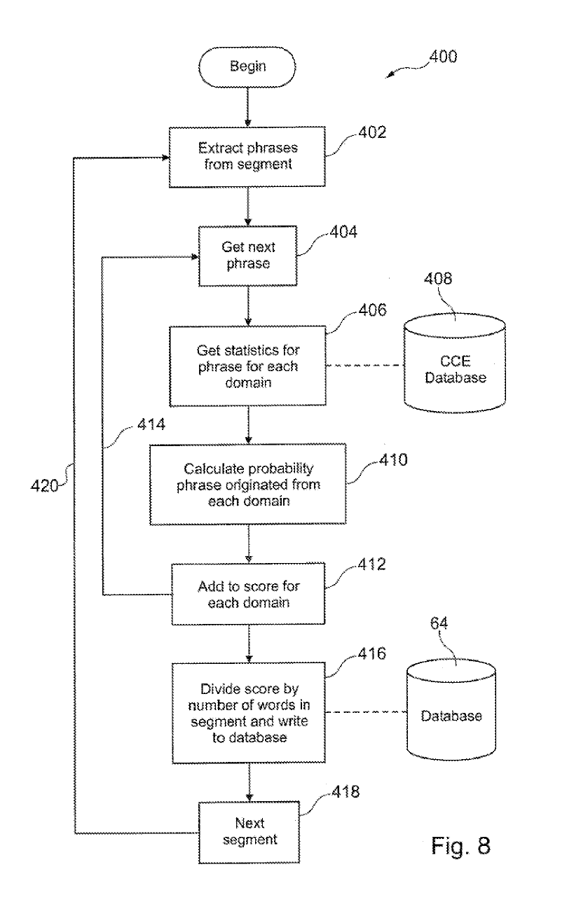

The operation of the CCE 48 to generate phrase domain scores will now be described with reference to FIG. 8. The CCE 48 basically identifies all the two to five word phrases in a conversation segment for a one of the parties, and for each of the two to five word phrases asks the question “which domains does this word phrase fall in?” in order to arrive at a cumulative measure of which domains the conversation segment falls in.

Take the example conversation segment of one of the parties, comprising the three separate messages:

### Hi

### HowRU

Whr do U live would U like 2 meet
(in which all punctuation has previously been stripped from the original text), if the conversation segment length is 15 words, then the software may automatically add a further two blank words in order to allow the segment to be processed if, for example, a time out has expired before a fourth message of the party is received.

The conversation segment scoring method 400 initially extracts all five, four, three and two word phrases for the segment at step 402 using the method described above. Then a first phrase is selected at step 404. For example the first five word phrase “Hi How R U Whr” can be selected at step 404. Then at step 406 a database query is carried using the CCE database 408 data as represented by database schema 300. For each domain 260 represented in the CCE database 408, the number of hits in a particular domain for the same word phrase is determined using the de-normalized phrases. The number of words in each domain 260 is determined as well as the total number of domains 260. For example, the phrase “Hi How R U Whr”, via its canonical equivalent “hi how are you where”, may exist in a number of different domains 260 and the number of hits in each domain 260 is retrieved at step 406 together with the number of words in each domain 260. The number of words in each domain 260 is calculated using the de-normalized phrases 290 in that domain 260. This gives a score s(D) based on the de-normalized phrases 290 in each domain 260. (A subsequent score based on the canonical phrases 280 in each domain 260 is also calculated which can also be used to analyze the relationships between two parties.)

If the canonical phrase 280 is not found to exist in any of the domains 260, then the canonical phrase 280 is ignored and processing returns to step 404 and a next canonical phrase 280 is selected for analysis.

At step 410 the probability p(D) that the canonical phrase 280 originated from each one of the domains 260, D, is calculated for each of the domains 260 in which the canonical phrase 280 has been found to exist as will be described in greater detail below. Then the score for the current canonical phrase 280 is updated for each domain 260 at step 412. That is the current score, s(D), for a particular one of the domains, D, is incremented by the product of the number of words in the phrase, n, (in this example, five) multiplied by the probability, p(D), as follows: s(D)=s(D)+n*p(D). Processing then returns, as illustrated by return line 414 to step 404 and a next one of the canonical phrases is evaluated and scored. Processing proceeds in this way until all of the five, four, three and two word phrases in the segment have been scored and the processing proceeds to step 416.

At step 416, the scores for each of the canonical phrases are divided by the number of words in the segment, in this example, fifteen, and the scores, s(D), written to the database 64 for later analysis.

Then processing proceeds to step 418 at which a next segment for a one of the parties is selected and processing returns to step 402 at which the canonical phrases 280 are extracted for the new segment. Processing continues in this way as completed segments become available for processing.

The phrase domain scores generated by this process contribute to the conversation DNA which is then analyzed by the relationship analysis engine 60. The conversation DNA can also include other numerical metrics generated by the other classification engine 60, such as the number of emoticons per segment, the number of spelling errors per segment, the number of punctuation marks per segment, etc.

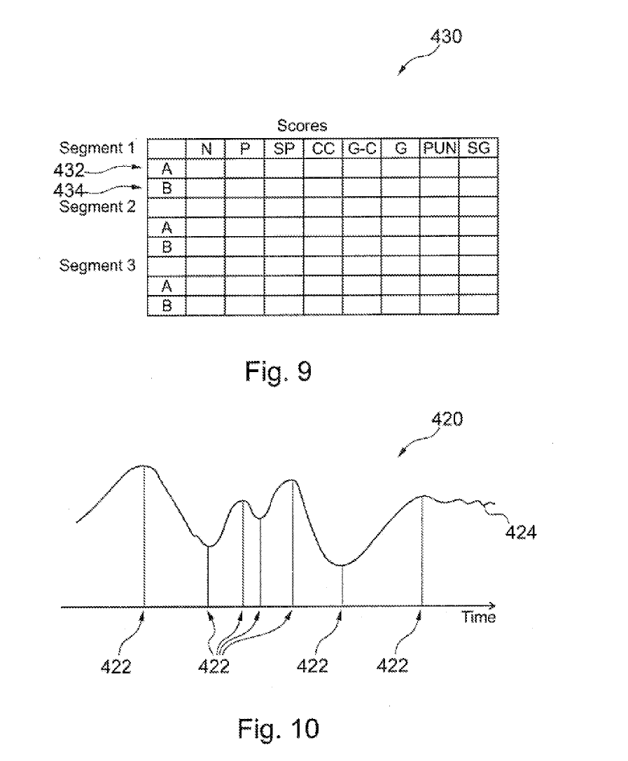

For example, FIG. 9 shows a data structure 430 by which the plurality of metrics or scores for a number of the conversation segments between two parties, A and B, can be represented. Columns N, P, SP, CC and GC include phrase domain scores obtained from the CCE 48 and columns E, PUN and SE include metrics of the number of emoticons per segment, the number of punctuation marks per segment and the number of spelling errors per segment respectively. The first two rows 432, 434 represent score data items from a first conversation segment between A and B, the fifth and sixth rows represent score data items from a second conversation segment between A and B and the eighth and ninth rows represent score data items from a third conversation segment between A and B. It will be appreciated that fewer or more domain name scores can be used and also that in practice fewer or more conversation segments can be used. Each consecutive conversation segment will illustrated the changes with time of the conversation between the two parties A and B. Scores are available for the conversation segments of each party A and B, separately. Analysis of the relationship can be based on one or more of the scores for a single one of the parties A and B, one or more of the scores for both parties A and B to a conversation, or one or more scores for the first party e.g. A and multiple other parties, with whom the first party A also has conversations.

Hence each conversation segment is represented by a string of numbers which characterize a number of different properties of the conversation. These strings of numbers, the conversation DNA, can then be analyzed by one or more analysis procedures by the relationship analysis engine 60. The domain scores for domains generated from the documents 270 are all calculated in the same way as indicated above. For handcrafted domains 260, based on selected lists of words or phrase, rather than based on document indexing, the canonical phrases 280 are assigned a probability of 1 when they are the same.

Other metrics, such as word length or number of emoticons, have there own specific metric or score which simply needs to be consistently calculated by the software.

The relationship analysis engine 60 is applied to the conversation DNA scores to find patterns in the relationship between the two users A and B. The analysis is intended to be able to distinguish between online grooming conversations and bona fide teenage chat conversations. Some possible dimensions of the conversation DNA and the calculation of values for each dimension over a segment of conversation are described below.

A number of different relationship analysis approaches can be used, individually or in combination. A first relationship analysis approach is based on basic indicative scores, that is simply the values of the relationship scores for the different dimensions of the conversation DNA. A second approach is based on basic or simple relationships, that is, the relative values of the dimensions of the conversation DNA between the two users A and B. A third approach is based on the conversation writing style. This can be characterized by scores representing a number of factors, such as a change of topic rating, the conversation pace, use of punctuation, average word length, emoticon usage, line length, etc. A fourth approach can be based on the style of the dialogue between the two users 12, 14 and the degree to which the style of the dialogue is indicative of deception. This can be characterized by relationship scores representing a number of factors, such as number of words used per phrase, number of questions asked, sentence length, self-oriented pronouns, other oriented pronouns, sense based descriptions, use of sense based descriptions for each user, etc. A fifth, statistical or probability based approach can be based on a Bayesian decision using a Markov chain. Clustered primitives describing the relationships are analyzed to give a probability that a conversation is a grooming conversation or normal chat conversation from a temporal flow of relationship primitives.

The above approaches use relationship scores for some or all of the following different ways of characterizing the content of the conversation referred to herein as the dimensions of the conversation DNA in order to identify relationships between the two parties A and B. The conversational and deception analysis approaches can also use more in depth analysis such as vocabulary used, topics discussed and speed of response. All messages 38 are time stamped so quantities such as average time to respond and words typed per minute can easily be calculated. These relationship scores are typically calculated over a segment size of several tens of consecutive lines of messages 38 from any one user, for example fifty lines. The scores are calculated during analysis by the CCE at step 210 of FIG. 4 by matching against known phrases (and misspellings of those phrases) for each dimension of the conversation DNA as generally described above.

The dimensions of the conversation DNA which are scored can include the following: sexual activity; masturbation; friendliness; general conversation; profanities; aggression; requests for personal information; isolation (e.g. loneliness, depression, being home alone, unprotected, vulnerable, etc); coercion (attempts to manipulate, influence or persuade); trust (questioning of trust, secrecy or the chances of being detected); pronouns; questions; word length; and line length.

Basic score based relationship analysis approaches can use some or all of the relationship scores calculated for the dimension of the conversation DNA detailed above. For each dimension (Dn) a relationship score can be calculated using:

$$Score ( Dn ) = {\sum }_{1}^{p} P ( Dn / phrasep ) * Length ( phrasep ) / number\_of \_words \_per \_segment$$

$$where$$

$$P ( Dn \backslash phrase ) = P ( phrase \backslash Dn ) * P ( Dn / P ( phrase )$$

is the posterior probability of a domain 260 given a certain phrase, the sum is over the p different phrases in the domain 260, Length (phrase p) is the length of phrase p, P(phrase|Dn) is the probability of a canonical phrase 280 occurring in a given domain Dn, and is given by hits in the domain 260 (i.e. number of matches to canonical phrase in the domain 260) divided by number of words in the domain 260, P(Dn) is the probability of a given domain 260, and is given by 1 divided by the number of domains 260 and P(phrase) is the prior probability of the canonical phrase occurring over all data and is given by

$$P ( phrase ) = \frac{1}{N} * {\sum }_{n = 0}^{N} P ( Phrase / Dn )$$

where N is the number of domains 260 and P(Dn) is calculated from the document indexing data.

If a ‘hand-crafted’ domain, i.e. one not based on document analysis but simply from a specific created list of canonical phrases, then

P(Dn|phrase)=1

and

P(Dn)=1/number of dimensions.

For example, based on this relationship analysis approach, a high score for the sexual domain 260-3 or Personal Information domain can be considered indicative of a potentially threatening relationship.

A basic relationships based analysis approach can be based on the relative relationship scores between the parties (A and B) to a conversation for a given DNA Dimension, e.g., the absolute difference between the relationship scores for the parties A and B on each dimension. For example, parties showing a large difference in Sexual and Friendly scores can be considered indicative of a potential grooming situation with one user, e.g. A, being very sexual and the other user, e.g. B, being much less friendly towards them. Sexual conversations between two teenagers in a relationship would be likely to show similar levels of sexual and friendly behavior and so that conversation may be considered unlikely to be a grooming conversation, despite some of the Sexual scores being high.

Relative scores are a measure of similarity and are calculated using A and B, where A is the maximum score from party A and party B and B is the minimum score. The relative score can be calculated using:

$$S ( r ) = 1 - \frac{A - B}{A}$$

For example, if the parties A and B are sexual teenagers, then the party A may have a sexual score of 0.75 whilst the party B may have a sexual score of 0.7. The relative sexual score would then be 0.93 showing that these sexual scores are highly similar. This relative sexual score is in effect a probability of how similar the two sexual scores are, as identical scores would have a relative sexual score of 1.0.

Similarly if the two parties 12, 14 also have similar levels of friendliness scores (i.e. a high relative score for friendliness) combined with high sexual scores this may show a teenage boyfriend and girlfriend chatting with each other. A potential grooming conversation would be more likely to show low relative scores for friendliness with low relative scores for sexual behavior also.

A relationship analysis approach based on conversation style can consider variation of the follow factors over the conversation. The topics covered can be relevant and can be determined using latent semantic indexing. The pace (i.e. the average response time of the parties and the difference in response times) can be relevant. This can be determined by collecting data representing the time that the messages 38 are received by the system 300 and using a module to calculate the average response time of each party A and B and difference. The alternation between the users A and B can also be relevant and can be measured or scored by the ratio of the average number of responses to each message 38. The writing style of each party A and B can also be relevant. This can be scored or measured by a number of properties, such as the amount of punctuation, use of emoticons, spelling, word length, line length, use of acronyms, and use of questions. Scores can be calculated as an average per number of words in the segment so that scores are not skewed by the length of any responses over a 50 line segment.

For example, a teen conversation would show a number of topics discussed, a high rate of topic change, fast average response time, little difference in the response time (between the parties and similar writing styles. Whereas, a potential pedophile/adult conversation with a child would be characterized by very few topics discussed with little change in topic, slower average response time with greater difference between response times (as the child gets wary) and a high dissimilarity in writing styles.

For each segment, topic of conversation (where a topic is any division of conversational data into semantic clusters, and so some topics may be equivalent to some of the domains) with the highest relationship score is identified. The relationship score is calculated by finding average relationship scores for each word hit on each topic and multiplying by the proportion of words in the whole segment which match that topic. The topics used can be found by Latent Semantic Analysis which finds its own semantic clusters in a given data set. The relationship scores for each word on a particular domain 260 can be calculated using Latent Semantic Analysis.

Latent Semantic Analysis (LSA) is a mathematical matrix decomposition technique similar to factor analysis that can be applied to bodies of text. Representations derived by LSA can be capable of simulating a variety of human cognitive phenomena including word categorization. The resultant matrix gives a score for each word on a given topic. Words not known to the system can be assigned an arbitrarily low score. Possible topics would include Sport, General Chat, Music, Sexual, etc. Change of topic can be turned into a probability related to an average change of topic (over multiple segments) for normal chat data as described for producing probabilities for conversation style.

For example, with all relationship scores presented as a value between 1 and 0, the following relationship scores could be considered indicative of a wary teen and therefore of a potential grooming relationship:

| | |
|---|---|
| Change in Topics Discussed | 0.1 (i.e. very little change) |
| Average response time | 0.2 (i.e. slow) |
| Difference in response time | 0.9 (i.e. high) |
| Dissimilarity in Writing Style | 0.85 (i.e. high) |

Age and gender related indicators can also be included.

To find an indicator of Age, a correlation is obtained between Age of the party and the scatter plot resulting from a dimensionality reduction technique such as Principal Components Analysis. Principal Component Analysis can be used to reduce the dimensionality of quantities relating to the writing style of the user as described above. If a correlation is identified, then regression techniques can be used to find a relationship between the principal component axes and the age of the user. Suitable regression techniques include linear regression, cubic spine regression and radial basis function networks.

To find indicators of Gender, various factors involved in writing style (as described above) can be analyzed to try and find clusters relating to gender. Classification techniques can then be used to find a decision boundary between clusters such that new data can easily be classified. Suitable classification techniques include Bayesian Decision Theory and Regression based methods. The multiple dimensions involved in writing style can be reduced via Principal Component Analysis, before the decision boundary is sought.

The output from both Age and Gender based methods can be used in the Real Time Rules Engine. The output from the Age related indicator function can also be used as the relationship score by considering the predicted relative ages between the two parties. Converting the relative age score to a probability can use a combination of age plus difference in age for the two parties.

A relationship analysis approach based on conversation content indicative of deception can also be used. Research on linguistic analysis of deception has shown that the deceiver and receiver behave in definable ways. In particular, the deceiver tends to use more words overall, a decreased number of self-oriented pronouns, an increased number of other oriented pronouns and more descriptions based on the senses, such as seeing and touching. The receiver meanwhile tends to use shorter sentences with more questions and more overall words.

Further theory on deception also shows that deceivers tend to employ Linguistic Style Matching (LSM) in which the deceiver adjusts their writing style to that of the receiver presumably to endear themselves, and appear friendlier and less alien or threatening. This can be measured using the following factors: convergence of writing style, measured by the dissimilarity between writing styles of the parties over time; and convergence of vocabulary, measured by the proportion of similar words used and how this varies over time. Hence LSM will be indicated by decreasing dissimilarity between writing styles and vocabulary used.

A statistical based relationship analysis approach based on Bayesian and Markov chain analysis will now be described. In this approach any number of dimensions (for each user) can be clustered into a set of states, and the results used in a Markov chain to look at common state transitions seen in conversations. Expected clustering seen in normal teen chat conversations and pedophile type conversations can be characterized by: normal chat conversations—high scores on general and friendly categories, short word length and very low scores on other categories, for both parties; and pedophile conversations—high scores on sexuality, masturbation, coercion and trust with long word and sentence length, for the pedophile and high diffidence with short sentences and high number of questions for the child.

Not all of the domains 260 will have appreciable relationship scores throughout the conversation, hence only those domains 260 with the relevant relationship score are shown. A typical set of transitions showing the magnitude of relationship scores on each dimension are shown in the table below. These have been based on research into grooming and the stages pedophiles often use during a conversation. Here the pedophile proceeds by first befriending the child and then doing a risk assessment. This ascertains the pedophile's chances of being detected, by asking questions such as whether the child is home alone and who else uses the computer. The pedophile then persuades the child that it is an exclusive relationship by questioning trust and using coercion. The child gets friendlier and progressively less isolated as they feel the adult is now a close friend they can trust. The pedophile then proceeds to sexualize the child by introducing the child to masturbation and mild sexual references. Whilst the child is initially slightly diffident and less friendly the pedophile persuades him/her with manipulative coercion by referring to their exclusive relationship and trust established. The child is then progressively sexualized with increasing coercion and ever more explicit sexual and masturbation references. This culminates in the pedophile asking for a meet up of some description.

| Time step | Pedophile | Child |
|---|---|---|
| T = 1 | Friendly - medium | Isolation - medium |
| | General - medium | General - medium |
| T = 2 | Friendly - high | Isolation - high |
| | Personal Information - medium | Friendly - medium |
| T = 3 | Friendly - high | Isolation - low |
| | Trust - high | Friendly - high |
| | Coercion - low | |
| T = 4 | Sexual - low | Diffidence - low |
| | Masturbation - low | Friendly - medium |
| | Coercion - medium | |
| T = 5 | Sexual - medium | Friendly - high |
| | Masturbation - medium | Sexual - low |
| | Coercion - high | Masturbation - low |
| | Trust - medium | |
| T = 6 | Sexual - high | Friendly - high |
| | Coercion - high | Personal information - low |
| | Personal Information - high | Sexual - low |

Clustering and calculation of transition probabilities can be based on either the relationship score values given above (here discretized into low, medium and high) or on vectors describing the change in the relationship score values between two conversation segments as described below.

The Bayesian approach combined with Markov Chains is used to analyze the temporal flow of dimensions of the conversation DNA and their relationships. The Markov Chains are used to calculate probabilities of transitions from one state to another, where states are sets of clustered primitives describing information about the dimensions. These clustered primitives are produced by simplifying the DNA data into a set of vectors which are clustered using an unsupervised Kohonen neural network.

The analysis method includes five general steps. The first step is the segmentation of dimension graphs. The second step is the production of representative Vectors. The third step is the clustering of vectors. The fourth step is the calculation of dynamical transitions between clusters, the fifth step is the integrating of the resulting probabilities.

The number of dimensions of the conversation DNA for analysis and the number of parties (i.e., A and/or B) considered are variables. Initially the patterns and dynamical patterns of one of the parties (A or B) over one or two dimensions can be considered, followed by both parties over one or two dimensions. It is also possible to analyze one or both parties over multiple dimensions to find more complex patterns of interaction.

The first step of segmentation is illustrated by FIG. 10 which shows a graphical representation 420 of the variation of a domain score, e.g. sexual, for a one of the parties as a function of time. Segmentation of the dimensions can be achieved using the gradient to distinguish changes in behavior. The dimension scores over time are segmented using maxima and minima (points of zero gradient), as illustrated by the vertical lines 422 in FIG. 10. The resulting segments are then placed in sectors to give an approximation of the direction and magnitude of change seen within each segment. Any small variations in the dimension score, as illustrated by wavy section 424, can be ignored, for example removed by applying a smoothing function to the relationship score data.

In order to capture general trends in the relationships between dimensions for one party and between parties A and B, the size and magnitude of the gradient is sectorized into a small number of possible values. These values relate to the general size of the gradient or change over a given segment. In particular High positive, Medium positive and Low (positive or negative) are used along with High negative and Medium Negative. These values are mapped onto values between −2 and +2 as shown below:

### High Positive->+2

### Medium Positive->+1

### Low Positive or Low Negative->0

### Medium Negative->−1 High Negative->−2.

Similarly the magnitude of the relationship scores is discretized into values for low, medium and high, using values such as 1, 2 and 3. Hence a vector for one party user on two dimensions would have four values relating to two value values for each dimension (magnitude and gradient), whilst a vector for two parties on two dimensions would have eight values relating to four values for each party (two magnitudes and two gradients).

The next step clusters the vectors. Vectors are clustered to find common general relationships between dimensions which can be used to classify the given data. A Self Organizing Kohonen neural network can be used because it is an unsupervised method which decides on the number of clusters according to patterns found in the data. The resulting clusters are defined as CI, C2 to CN where N is the number of clusters found in the data.

The next step is to find dynamical transitions between the clusters. Markov Chain analysis is used to look at the transitions between the clusters over time. Hence temporal patterns can be captured using first order transitions between one cluster and the next cluster. This gives the probability of those two clusters appearing one after the other in the data. Longer transitions can also be considered at a later date using 2^{nd} and 3^{rd} order Markov Chains which capture the transition between 3 and 4 clusters over time. This will show complex temporal patterns of interaction over time hence flagging up common strategies used in the pedophile data. These probabilities are calculated by analyzing the patterns over known pedophile data and producing probabilities of a given transition occurring. These probabilities are then multiplied together to give a probability of a given sequence of transitions occurring in known pedophile data, using

P(T=t1, t2, . . . , tn\pedophile)=p(t1)*p(t2)* . . . *p(tn)

where p(t1), p(t2), etc are the probabilities of transitions at the times, t1, t2, etc.

The final stage of the integration of probabilities is dependent on the data available.

The probabilities calculated above can be used as sole indication of the probability of pedophile data if only data obtained from the pedophile conversations is available. Further, the probabilities generated from different analyzes (i.e. analyzes over different sets of dimensions) can be combined to give an overall level of likelihood. Various ways for doing this exist, including a very simple average calculated by multiplying all probabilities and dividing by the number of different analyzes being combined. This can be combined with a measure of spread showing the similarity of values being combined. One such method is to use the principle of entropy which measures the degree of disorder in a set of values; hence any set of data with a large variation in values will have high entropy whilst those with very similar values will have low entropy. More sophisticated data fusion methods can also be used such as the Fisher-Robinson Inverse Chi Square method.

If data from pedophile conversations and data from teen chat conversations are both available, then Bayesian decision theory can be used to calculate the probability of the data being from the pedophile given a certain set of transitions. The same can also be done on the normal data to calculate the probability of the data being from a known user given the same set of transitions, using

P(pedophile\T=t1, t2, . . . tn)=P(T\pedophile)*P(pedophile)/P(T)

where P(pedophile) is the proportion of pedophile data in whole data set and P(T=t1, t2, . . . tn) is the probability of transitions T occurring in the whole data set. The results from various analyzes on different sets of dimensions are combined in the same way as discussed above.

After the relationship analysis engine 60 or engines have completed, the relationship score aggregator 62 can generate a single metric representative of the nature of the conversation or probability that the conversation is a grooming conversation. For example, the relationship score aggregator 62 can take as input the metrics generated by a number of the different relationship analysis engines 60 and output a single metric, for example a risk rating within the range 1 to 100, that the relationship is a grooming relationship. For example, the relationship score aggregator 62 can take as input a metric representing the ratio of the number of sexual terms in the two parties A and B messages, a metric representing any increase in sexual content and any decrease in friendly content, a metric representing the average word length, number of emoticons and level of punctuation. A weighted sum of these metrics divided by a maximum possible total and expressed as a percentage can then be output as the risk rating by the relationship score aggregator 62.

A high ratio of sexual terms can be an indicator that the pedophile is communicating with the child, but could also simply be a conversation between two adults, in which one of the adults is not sexually interested in the other. An increase in sexual content over time and a decrease in friendliness could be an indication that the pedophile is moving the conversation on from innocent subjects once trust has been gained. On the other hand, it could also be an indication of an adult relationship moving from a platonic one to a sexual one. A high average word length, incorrect use of emoticons and high level of punctuation might be characteristic of an adult's email habits but not those of a child.

Therefore, by combining or aggregating these individual scores, a more accurate indication of the risk that the conversation is a grooming conversation can be obtained compared to a single score alone.

Other approaches can be adopted to combine the scores from the relationship analysis 30 engines 60.

In another embodiment, the relationship scores aggregator 62 can produce an overall threat score from the results of multiple of the different relationship analysis approaches described above so that a probability of threat can be ascertained. The first four approaches can trigger a warning if the relationship scores reach a certain given level. However these relationship scores can be transformed into probabilities by comparing such relationship scores with average values known for teen chat conversations. The amount of deviation from the averages can be measured against a multiple of the size of the average values and turned into a resulting probability. Having ascertained a probability of threat for each approach some, or all, of the calculated probabilities can be combined by the relationship score aggregator 62 to provide an overall threat score. Mathematical data fusion techniques provide ways of combining a number of probabilities. Examples include Bayesian Combination, Robinson's Geometric Mean and Fisher-Robinson's Inverse Chi Square methods.

Methods for producing probabilities from the relationship scores and the relative relationship scores will be described first. Determining the average values of relationship scores av_{DNA} (and relative relationship scores) for all dimensions and combinations of dimensions from known teen chat conversation data gives a base line for calculating a probability of threat score. The maximum deviance from this relationship score could be defined as n*av_{DNA}, where n is a positive integer greater than 1 and where n*av_{DNA} gives an upper ceiling for calculating deviance from the average scores. Hence a threat probability is diff, given by diff=(score−av_{DNA}J/(n*av_{DNA}−av_{DNA}). In an example given below, n is set to 3.

This can be used for the basic relationship scores on dimensions which are known to be threatening such as sexual, masturbation, Personal Information, Trust, Coercion, Profanity and Aggressiveness. For such relationship scores those diff values <0.0 would be ignored whilst those where threat would be associated with less than the average relationship scores would ignore diff values >0.0. The probability is then the absolute value of diff. For relationship scores the absolute difference between the relationship scores is more important and this is measured against the known average as described above. Those relationship scores or relative absolute relationship scores exceeding the maximum mark of n*av_{DNA} would have a threat probability of 100 percent.

Methods for producing probabilities from conversation style scores will now be described. As described above the known average relationship scores on each dimension can be used to calculate a relationship score showing the difference between values for two parties. The alternation rate can be assumed as 1:1 for a normal conversation and deviances from this can be calculated using 3:1 as a maximum level of difference. Those parameters pertaining to writing style such as emoticons, questions, word length, and spelling would all be compared against an average per number of words to stop the size of each line skewing the relationship scores. Again a probability would be calculated using the absolute relative difference of relationship scores from a known av_{DNA} value.

These relative relationship scores between the two parties can be combined with the relationship scores for the conversation such as average pace and number of topics used, which can be scored by the absolute difference from the av_{DNA} value as described above. Having reduced all the relationship scores to a probability where all factors have an equal weighting, an overall probability can be produced to indicate the overall difference in writing styles of the two users.

Methods for producing probabilities from deception indicators will now be described. Linguistic Style Matching (LSM) can be measured by the decrease in difference in writing styles over a conversation as the difference is already a probability. Similarly for the changes in the similarity of vocabulary used. The similarity of vocabulary used can be measured by the increase in the proportion of similar words used by the parties.

Other factors indicating deception are a high number of words for the receiver and a high number of questions, a high number of words for the deceiver, little use of self-oriented pronouns, high use of other-oriented pronouns and high use of sense based description. These can be calculated as probabilities using the average values of such metrics seen in known teen chat conversations. Deviation from the average in the required direction then can be transformed into a probability as described above and combined with the other probabilities to produce an overall probability of the deception occurring.

Hence, the relationship scores aggregator 62 can combine the probabilities from the different relationship analysis engines 60 and generate a single probability or risk that the relationship is a grooming relationship.

As described above, the output of the relationship scores aggregator 62 can be passed to the decision rules engine 56 and used to determine what action should be taken. For example, the decision rules engine 56 may include logic specifying that if the grooming risk score output by the relationship scores aggregator 62 exceeds a first threshold, e.g. 50%, then the events module 66 is called to send a warning email to a parent of the child, and if the grooming risk score output by the relationship scores aggregator 62 exceeds a second threshold, e.g. 75%, then the events module 66 is called to send a warning email to another trusted party, e.g. the police, and also to prevent further messages being passed between the parties.

The exact combination of relationship scores and other data which can be considered indicative of grooming, or any other inappropriate behavior, maybe a complex combination of factors. For example a decrease in a friendliness score may not in itself show that there is a grooming relationship but may merely indicate that there is an argument between the parties (A and B). However, a decrease in friendliness score in conjunction with an increase in a sexual content score may indicate a high likelihood of a grooming relationship causing the relationship score aggregator 62 to output a high risk score resulting in action being taken.

As discussed above, the decision rules engine 56 may make its decision based on data other than the relationship risk score output by the relationship score aggregator 62. For example, a high sexual content score in combination with a user age indicating a child, may be considered to indicate a high likelihood that somebody is posing as a child or using a child's email account in order to groom another child. This may result in action being taken to block further communications and to notify relevant authorities.

As will be appreciated, the invention is not limited to the embodiment described in FIG. 3 which provides a sophisticated approach suitable for integrating with ISP services. In other applications, the invention may be provided in simpler forms, for example by omitting many of the modules illustrated in FIG. 3.

For example, the invention can be used in conjunction with a social networking website, such as myspace, or similar. All messages passed between every unique pair of members of the site are copied to the API 34. The service control manager 44 then calls a number of the classification modules, including the CCE 48, and on a conversation segment basis, a single relationship score for each pair is generated, either from a single relationship analysis routine or an aggregated relationship score, and passed by the service control manager 44 back to the social networking website. This would operate in an asynchronous mode so as not to interrupt real time messaging. However, the social networking website can then use the relationship score data to analyze the users of the website to identify unwanted behavior. For example, a user who has a large number of relationships with other users and who has a high sexual content score for all those relationships might be considered a potential groomer. Alternatively, a user who has a large number of relationships with other users and who has a some grooming risk score for all those relationships might be considered a potential groomer.

Software is available for visualizing social network data (such as, e.g. Vizster, by Jeffrey Heer and Danah Boyd of University of California at Berkeley) In which all relationships of a particular user are illustrated graphically by the distance between a user and all other users with whom they have a relationship. By making the separation inversely proportional to any grooming risk score, a clump of users centered on the user might be considered indicative of the user being a groomer present in the social network. Hence, the decision rules engine and real time rules engine and events module are not required.

In another embodiment, the real time rules engine 58 and the decision rules engine 56 can be omitted and the relationship scores generated by the relationship score aggregator 62 can be passed to the events module 66 which determines what action to take.

In another embodiment, the CCE 48 can carry out its scoring on a message by message basis, rather than using conversation segments, and send score data to the events module 66 which likewise can take action on a message by message basis. This embodiment is particularly suitable for synchronous applications as real time action can be taken as messages are being received.

In another embodiment, suitable for synchronous applications, the real time rules engine 58 can be used together with the service control manager 44, the conversation cache 46 and the CCE 48 to determine whether a messaging service should allow messages to be passed or blocked and passing that decision back to the client of the messaging service to take the necessary action. Hence, the events engine and decision rules engine are not required.

In one embodiment, the invention can be used to try and assess the nature of relationships based on the postings of a party on a bulletin board, those postings effectively being one side of a one-to-many conversation. The relationship can be analyzed based on the scores solely of the messages posted by the party, or can include analyzing the scores for any messages received from one or more other parties in reply to the bulletin board message. This in effect considers multiple relationships in parallel and can help to identify unwanted relationships that might not be identified based on a single conversation alone.

Hence, various different combinations of the modules shown in FIG. 3 can be used depending on the particular application of the invention.

Generally, embodiments of the present invention, employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Embodiments of the present invention also relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

Although the above has generally described the present invention according to specific processes and apparatus, the present invention has a much broader range of applicability. In particular, aspects of the present invention is not limited to any particular kind of relationship or electronic communications mechanism and can be applied to try and identify any type of undesirable behavior based on messages transmitted at least partially via any type of electronic communications medium. Thus, in some embodiments, the techniques of the present invention could help identify potential security or public safety threats based on the presence of certain key trends in the conversation between parties or to identify potential espionage, for example, by a party sending emails to themselves at a different location so as to transfer important information out from an organization.

Further, the invention is not intended to be limited to the specific data processing operations and structures described herein. The invention may be implemented in various different ways and the functions and structures shown in the figures are by way of illustration to help explain the invention only. Unless the context requires otherwise, different data processing operations and different sequences of data processing operations can be used compared to the data processing steps illustrated in the Figures and the data processing operations illustrated in the Figures may be broken down into further data processing operations or combined into more general data processing operations depending on the implementation of the invention.

One of ordinary skill in the art would recognize other variants, modifications and alternatives in light of the foregoing discussion.

What is claimed is:

1. A method for the monitoring of relationships between two parties, comprising:
capturing a communication between the two parties;
processing the communication to obtain a set of metrics; and
processing the set of metrics with a stored set of values to establish a nature of the relationship.

2. The method of claim 1, wherein the processing of the communication comprises dividing the communication into a plurality of portions.

3. The method of claim 2, wherein the plurality of portions represents word phrases.

4. The method of claim 1, wherein the relationship is any one of a pedophile grooming relationships, a gambling relationship, an industrial espionage relationship or a financial fraud relationship.

5. The method of claim 1, further comprising notifying a third party of the nature of the relationship.

6. The method of claim 1, further comprising blocking at least part of the communication.

7. The method of claim 1, wherein processing the communication comprises concatenation of the communication to form a communication segment.

8. An apparatus for monitoring a relationship between two parties, comprising:
a buffer memory for storing a plurality of communications between the two parties;
a communications processor for processing the plurality of communications in order to establish a set of metrics;
a database for storing a set of values; and
an engine for processing with the set of metrics and the set of values to produce an indicator representative of the relationship between the two parties.

9. The apparatus of claim 8, further comprising a notifier to notify a third party of the indicator.

10. The apparatus of claim 8, further comprising a service control manager to control the processing of the communication between two parties.

11. The apparatus of claim 8, further comprising a blocker to block at least part of the communication between the two parties.

12. The apparatus of claim 8, further comprising a rules engine.

13. An interface to an application program, wherein the interface is adapted to monitor a plurality of communications between two parties, the interface comprising:
an identifier routine for passing identifiers representing the two parties from the application program to a monitoring system; and
a content routine for passing the content of the plurality of communications between the two parties to the monitoring system, wherein the monitoring system processes the plurality of communications with a set of metrics to establish the nature of the plurality of communications between the two parties.

14. The interface of claim 13, further comprising a metadata routine for passing metadata associated with the plurality of communications to the monitoring system.

15. The interface of claim 13, further comprising a blocking routine for blocking the plurality of communications between the two parties.

16. A listener device for monitoring a plurality of communications between two parties, comprising:
an interceptor for intercepting the plurality of communications between the two parties; and
a transmitter for passing at least identifiers representing the two parties and the content of the plurality of communications to a monitoring system, wherein the monitoring system processes the plurality of communications with a set of metrics to establish the nature of the plurality of communications between the two parties.

17. The listener device of claim 16, wherein the transmitter further sends metadata associated with the plurality of communications to the monitoring system.

18. A method for generating a set of values indicative of a relationship between two parties, comprising:
obtaining at least two training sets with a plurality of documents, each one of the at least two training sets representing an aspect of the relationship between the two parties;
identifying a set of domains representing the relationship;
processing the plurality of documents from each of the at least two training sets to establish a set of values for each one of the domains for each of the at least two training sets;
clustering the set of values for each of the at least two training sets; and
establishing a boundary between the clustered set of values.

19. The method of claim 18, wherein the clustering the set of values is carried out in multi-dimensional space.

20. The method of claim 18, further comprising a step of reducing the number of dimensions prior to clustering the set of values.

21. The method of claim 18, wherein the boundary between the clustered set of values is carried out by discriminant analysis.

22. The method of claim 18, wherein a first one of the training sets represents a pedophile grooming conversation and the second one of the training sets represents a child-child conversation.

23. The method of claim 18, wherein a further one of the training sets represents an adult-adult sexual conversation.

24. The method of claim 18, wherein processing of the plurality of documents comprises determining the word phrases present in the plurality of documents.

25. A computer program product comprising a computer useable medium having a control logic stored therein for causing a computer to monitor a relationship between two parties, the control logic comprising:
first computer readable program code means for causing the computer to capture a communication between the two parties;
second computer readable program code means for causing the computer to obtain a set of metrics from the communication; and
third computer readable program code means to process the set of metrics with a stored set of values to establish a nature of the relationship between the two parties.
